(19) United States
(12) Patent Application Publication
(10) Pub. No.: US 2013/0306569 A1
(43) Pub. Date: Nov. 21, 2013

(54) TECHNIQUES FOR WATER TREATMENT FOR HIGH-EFFICIENCY CLEANING

(71) Applicant: MAXIA INVESTMENTS LLC, Kingsport, TN (US)

(72) Inventor: Allen Johnston, Johnson City, TN (US)

(21) Appl. No.: 13/898,095

(22) Filed: May 20, 2013

Related U.S. Application Data
(60) Provisional application No. 61/655,595, filed on Jun. 5, 2012.
(60) Provisional application No. 61/649,023, filed on May 18, 2012.

(51) Int. Cl. C02F 1/78

(52) U.S. Cl. CPC C02F 1/78
USPC 210/739; 210/98; 210/85

(57) ABSTRACT

A water treatment device may comprise a photocatalytic oxidation (PCO) element, an oxide generation module, a flow switch, and a plurality of water-conveying elements. The oxide generation module may comprise a housing, an oxide generator, and a fan arranged such that, when the fan is powered on, a ducted flow of air passes along the oxide generator. The plurality of water-conveying elements may comprise a vacuum generation element. While the flow switch indicates that water is not flowing through the plurality of water-conveying elements, the PCO module and the oxide generator may be configured in an OFF state. While the flow switch indicates that water is flowing through the plurality of water-conveying elements, the following may be true: the fan may be configured in an ON state, the PCO module may generate ionized air, the oxide generator may add ozone to the ionized air, and a vacuum generated by the water flowing through the vacuum generation element may pull the ionized air containing ozone into the water.

### CROSS-REFERENCE TO RELATED APPLICATIONS

This application claims the benefit of U.S. Provisional Patent Application No. 61/649,023 filed on May 18, 2012, and U.S. Provisional Patent Application No. 61/655,595 filed on Jun. 5, 2013, the entireties of which are herein incorporated by reference.

### TECHNICAL FIELD

Aspects of the present application relate to water treatment. More specifically, to techniques for water treatment for high-efficiency cleaning.

### BACKGROUND

Existing techniques for treating water can be inefficient and provide unreliable operation. Further limitations and disadvantages of conventional and traditional approaches are discussed through comparison of such approaches with some techniques of the present application set forth in the remainder of this disclosure with reference to the drawings.

### BRIEF SUMMARY

Techniques are provided for water treatment for high-efficiency cleaning, substantially as illustrated by and/or described in connection with at least one of the figures, as set forth more completely in the claims.

### BRIEF DESCRIPTION OF THE DRAWINGS

FIG. 1 is diagram of a laundry system comprising a water treatment device, in accordance with techniques of the present application.

FIG. 2 is a diagram of an example water treatment device, in accordance with techniques of the present application.

FIG. 3A is a top view of an example oxide generation module, in accordance with techniques of the present application.

FIG. 3B is a front view of an oxide generation module, in accordance with techniques of the present application.

FIG. 3C is a right-side view of an oxide generation module, in accordance with techniques of the present application.

FIG. 3D is a left-side view of an oxide generation module, in accordance with techniques of the present application.

FIGS. 4A and 4B illustrate operation of a flow switch in a water treatment device, in accordance with techniques of the present application.

FIG. 5A is a cross-sectional view of an example vacuum generation element, in accordance with techniques of the present application.

FIGS. 5B and 5C illustrate operation of the check valve of the vacuum generation element, in accordance with techniques of the present application.

FIG. 6 is a flow chart depicting example steps for operation of a water treatment module, in accordance with techniques of the present application.

### DETAILED DESCRIPTION

As utilized herein the terms “circuits” and “circuitry” refer to physical electronic components (i.e. hardware) and any software and/or firmware (“code”) which may configure the hardware, be executed by the hardware, and or otherwise be associated with the hardware.

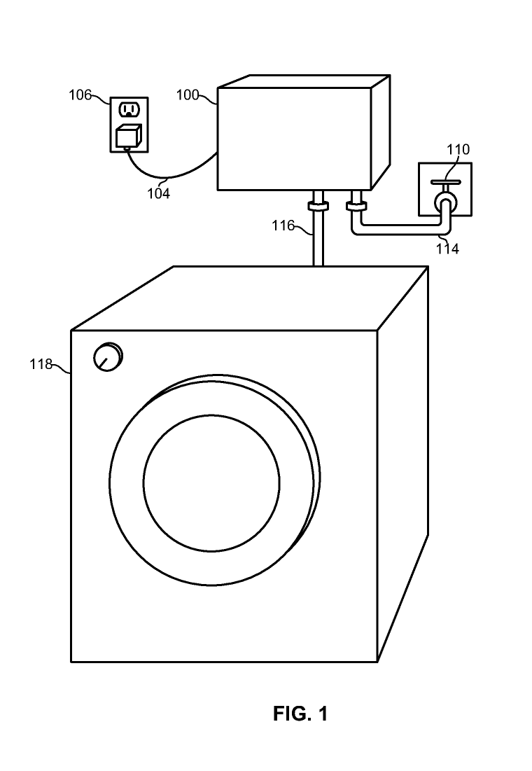

FIG. 1 is a diagram of a laundry system comprising a water treatment device, in accordance with techniques of the present application. The laundry system in FIG. 1 comprises a water treatment device 100, water hose 114, water hose 116, and washing machine 118. The water treatment device 100 comprises a power cord 104 via which it is plugged into an outlet 106. The water hose 114 connects a water input of the device 100 to a water faucet 110. The water hose 116 connects the device 100 to the washing machine 118.

In operation, water may be supplied to the washing machine 118 via the hose 114, the device 100, and the hose 116. When the washing machine 118 starts filling, the device 100 may detect that water is flowing and one or more components of the device 100 may be responsively configured in an ON state. In an implementation, when the components of the device 100 are in an ON state, the device 100 may generate ionized air and/or generate oxidants. The air containing ions and/or oxidants may be injected into the water that is flowing through the device 100, resulting in treated water. The treated water may then be output to the washing machine 118 via the hose 116. When the washing machine 118 is not filling, the device 100 may sense that water is not flowing and one or more components of the device 100 may be responsively configured in an OFF state.

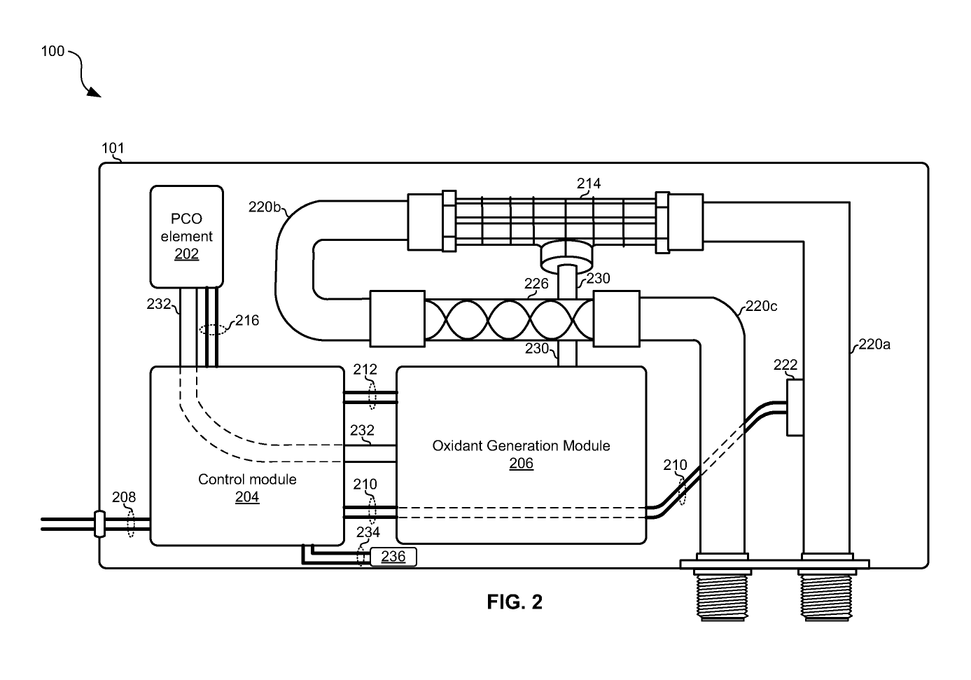

FIG. 2 is a diagram of an example water treatment device 100, in accordance with techniques of the present application. The example water treatment device 100 in FIG. 2 comprises: a housing 101, a photocatalytic oxidation (PCO) element 202; a control module 204; an oxide generation module 206; Electrical connections 208, 210, 212, 216, and 234; leak sensor 236; air-conveying elements 232 and 230; water-conveying elements 214, 226, 220a, 220b, and 220c; and flow switch 222.

Each of the water-conveying elements 220a, 220b, and 220c may comprise one or more hoses, pipes (e.g., PVC) and/or fittings. Each of the electrical connections 208, 210, 212, 216, and 234 may comprise one or more conductors (e.g., a positive wire and a negative wire). Each of the air-conveying elements 232 and 230 may comprise one or more hoses, pipes, and/or fittings.

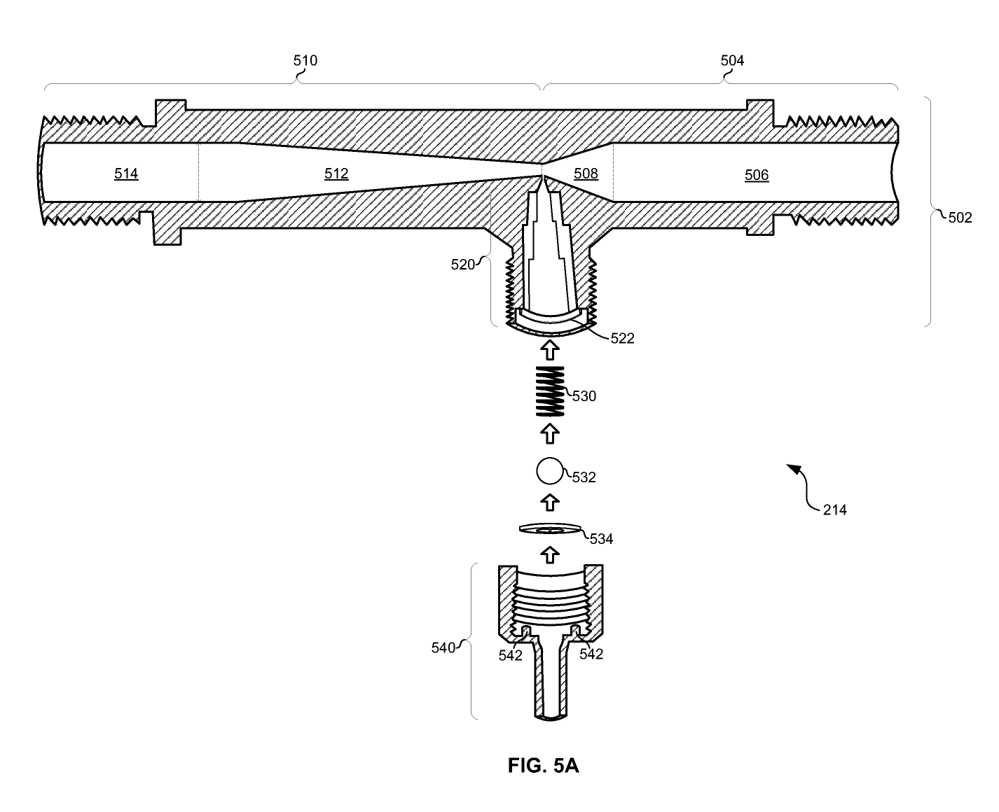

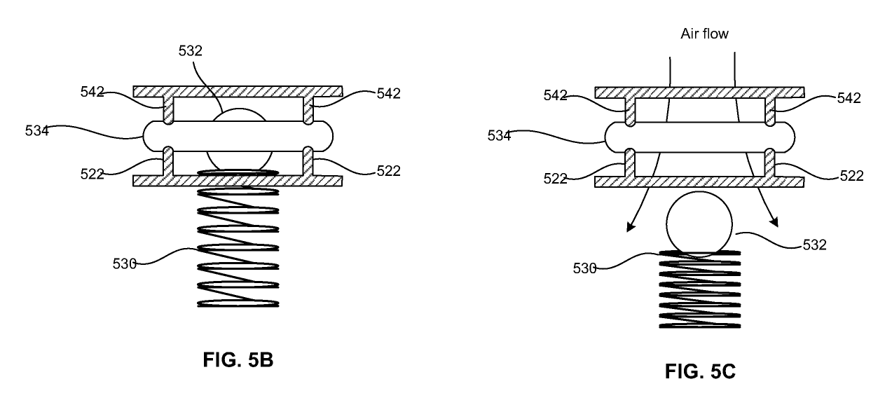

The water-conveying element 214 (referred to hereafter as vacuum generation element 214) may be configured such that water flowing through it creates a vacuum that pulls air from the air-conveying element 230 into the water. An example implementation of the vacuum generation element 214 is described below with respect to FIGS. 5A-5C.

The water-conveying element 226 (referred to hereafter as static mixer 226) may comprise paddles and/or other obstacles to the flow of water that cause the flowing water to be mixed. In this manner, the air pulled into the water at the vacuum generation element 214 may be better dissolved into the water.

The photocatalytic oxidation (PCO) element 202 may be operable to ionize air through photocatalytic oxidation. The PCO element 202 may, for example, combine ultraviolet light rays with titanium oxide to generate oxidizing ions. Air containing the generated ions may be output to the oxide generation module via the air-conveying element 232.

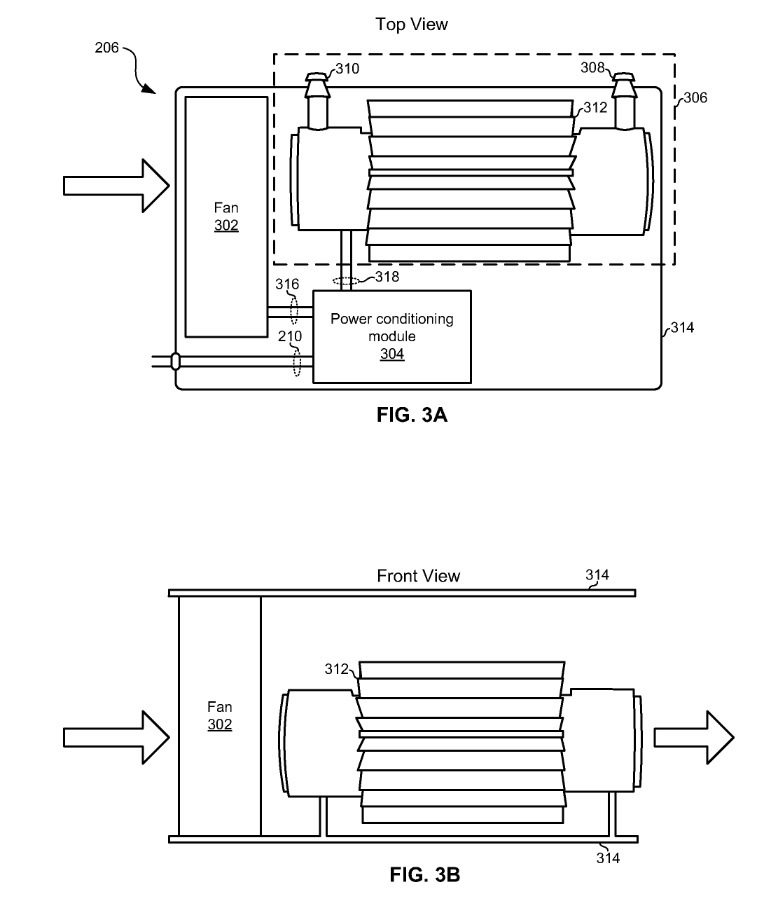

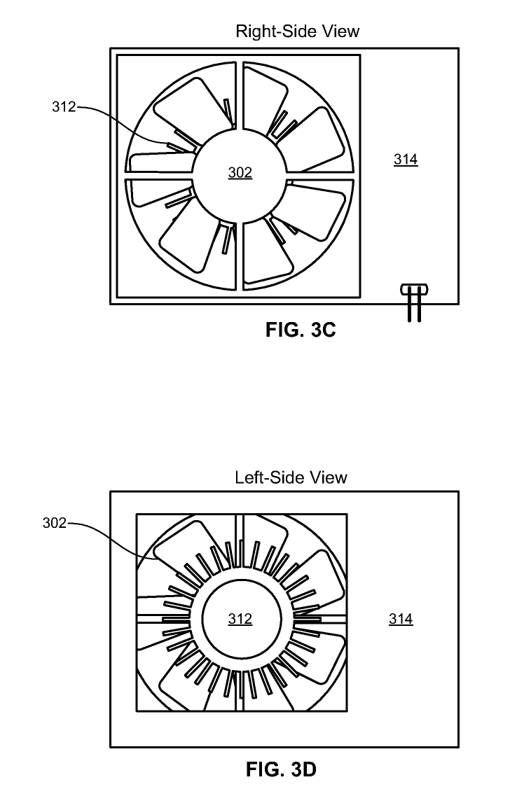

The oxide generation module 206 may be operable to receive ionized air via the air-conveying element 232, process the air to add oxidants (e.g., ozone) to the ionized air, and output the ionized air containing oxidants via the air-conveying element 230. An example oxide generation module 206 is described below with respect to FIGS. 3A-D.

The leak sensor 236 may detect when there is a leak in the system. For example, the leak sensor 236 may detect when water drips onto and/or pools inside the housing 101 (e.g., when water drips down an interior wall of the housing 101 or pools on the bottom of the housing 101). In one implementation, the housing 101 may be contoured and/or otherwise formed such that water inside the housing will flow toward the leak sensor 236 for detection. For example, the bottom of the housing 101 may slope toward the leak sensor 236 such that gravity guides water inside the housing 101 toward the leak sensor 236.

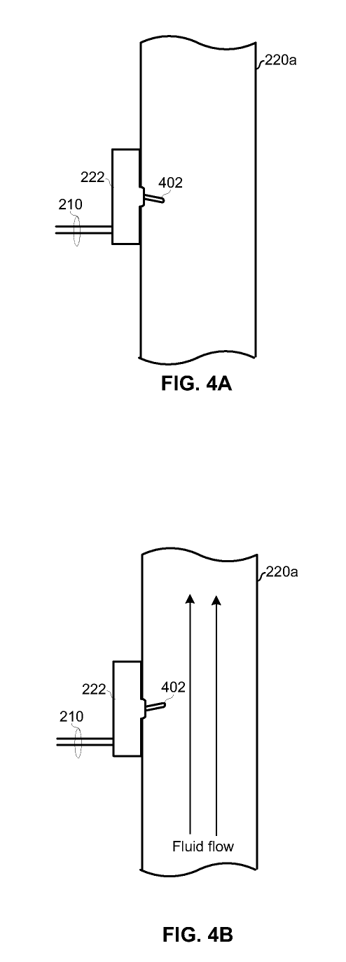

The flow switch 222 may be operable to detect when water is flowing through the water-conveying element 220a. The flow switch 222 may, for example, rest in an OFF position when water is not flowing through the water-conveying element 220a and may be pushed into an ON position when water is flowing through the water-conveying element 220a. Operation of an example flow switch 222 is described below with respect to FIGS. 4A and 4B.

The control module 204 may comprise circuitry for controlling operation of the PCO element 202 and the oxide generation module 206. The control module 204 may control operation of the PCO element 202 and the oxide generation module 206 based, at least in part, on input from the flow switch 222 and/or the leak sensor 236. The control module 204 may configure the PCO element 202 and/or the oxide generation module 206 into an ON state only when the signal on the conducting element 210 indicates that the flow switch is in the ON position. The control module 204 may configure the PCO element 202 and/or the oxide generation module 206 into an ON state only when the leak sensor 236 does not indicate a leak. The control module 206 may sound an audible and/or visible alarm when the leak sensor 236 indicates a leak. The control module 202 may configure a state of the PCO element 202 by controlling a supply voltage applied to the PCO element 202 via the conducting element 216. The control module 202 may configure a state of the oxide generation module 206 by controlling a supply voltage applied to the oxide generation module 206 via the conducting element 212.

In operation, when the washing machine 118 opens its valve to begin filling, water may flow through the water-conveying element 220a, causing the causing the flow switch 222 to move to the ON position. The control module 204, upon detecting that the flow switch 222 is in the ON position and that the leak sensor 236 is not indicating a leak, may configure each of the PCO element 202 and the oxide generation module 206 into an ON state. When the PCO element 202 is configured in the ON state, it may output ionized air to the oxide generation module 206 via the air-conveying element 232. When the oxide generation module 206 is configured in the ON state, it may add oxidants (e.g., ozone) to the ionized air, and output the ionized air containing oxidants via the air-conveying element 230.

After flowing through the water-conveying element 220a, the water may flow through the vacuum generation element 214. The vacuum created by the flow of water through the vacuum generation element 214 may cause a check valve in the vacuum generation element 214 to open and the ionized air containing oxidants to be pulled into the water. The water containing the ions and oxidants may then flow through the water-conveying element 220b into the static mixer 226. As the water flows through the static mixer 226, the ions and oxidants may better dissolve in the water, resulting in treated water. The treated water may then flow through the water-conveying element 220c and out to the washing machine 118.

FIG. 3A is a top view of an example oxide generation module, in accordance with techniques of the present application. The example oxide generation module 206 shown in FIG. 3A comprises a fan 302, a power conditioning module 304, an oxide generator 306, and a housing 314.

The oxide generation module 206 provides various benefits over certain existing techniques. For example, certain existing techniques provide only a scattering of independent elements without modularization. Yet, certain of these independent elements (e.g., a fan, power conditioning circuitry, and/or an oxide generator) may tend to decay, lose effectiveness, or even fail over time. The modular nature of the oxide generation module 206 facilitates efficient removal and installation into the device 100 and reduces the need for element-by-element troubleshooting.

The power conditioning module 304 may comprise circuitry for condition a voltage and/or current supplied to the fan 302 and the oxide generation module 306. The power conditioning module 304 may, for example, receive a first voltage via conducting element 210 and convert that first voltage (e.g., via a DC/DC converter) to a second supply voltage for powering the fan via conducting element 316 and to a third voltage for powering the oxide generator 306 via the conducting element 318.

The example oxide generator 306 comprises an input port 310, an output port 308, and heat-sinking fins 312 that extend radially in from a main body 320 of the oxide generator 306.

Ionized air from the PCO element 202 may enter the oxide generator 306 via the input port 310, and ionized air containing oxidants (e.g., ozone) may exit the oxide generator 306 via the output port 308.

The housing 314 may substantially enclose the oxide generation module 206 and create a one or more air ducts such that, when the fan 302 is powered on, air flows (in the direction indicated by the arrows) along the heat-sinking fins 312. In this regard, the ducted flow may force more air to pass over and between more of the fins 312 than may otherwise occur if the oxide generator 306 was not enclosed in the duct. In an implementation shown in FIG. 3B, the oxide generator 306 may be mounted away from the walls of the housing 314 such that the ducted air flow can substantially surround the oxide generator 306. The ducted airflow may enter the duct via a first opening in a first-side wall of the housing 314 (shown in FIG. 3C) and exit via an opening in a second-side wall of the housing 314 (shown in FIG. 3D).

In some implementations, an oxide generator may lose efficiency if its temperature becomes relatively high. Certain existing techniques fail to effectively regulate the temperature of an oxidant generator. Accordingly, the techniques disclosed in this application provide various improvements for regulating the temperature of the oxide generator 306 in the setting of a high-efficiency water treatment device. Such techniques, described herein, include providing ducting for the flow of air across the oxide generator 306. In an implementation, the housing 314 forms such a duct. Another technique described herein for regulating the temperature of the oxide generator 306 is aligning the long axis of the oxide generator 306 to be substantially parallel to the air flow coming from the fan 302. Yet another technique described herein for regulating the temperature of the oxide generator 306 is spacing the oxide generator 306 away from surfaces that may interfere with the transfer of heat to the air. Yet another technique described herein for regulating the temperature of the oxide generator 306 is providing radial heat-sinking fins 312 along the long axis of the oxidant generator 306.

FIGS. 4A and 4B illustrate operation of a flow switch in a water treatment device, in accordance with techniques of the present application. As shown in FIG. 4A, when no water is flowing through the water-conveying element 220a, the paddle 402 of the flow switch 222 is in a first position which may, in an implementation, correspond to an OFF, or open-circuit, position. As shown in FIG. 4B, when water is flowing through the water-conveying element 220a (as indicated by the arrows), the paddle 402 of the flow switch 222 is in a second position which may correspond, in an implementation, to an ON, or closed-circuit, position.

FIG. 5A is a cross-sectional view of an example vacuum generation element 214, in accordance with techniques of the present application. The vacuum generation element 214 comprises a water ingress portion 504, a water egress portion 510, a first air ingress portion 520, a second air ingress portion 540, and a check valve comprising a gasket 534, a ball 532, and a spring 530.

The gasket 534 may be made of an oxide-resistant material. The gasket may be contoured such that, when the ball 532 is pressed against the gasket 534, as shown in FIG. 5B, the gasket 534 conforms to the surface of the ball 532 and forms a seal. The spring 530 may be a metal coil or other device with suitable elasticity. When sufficient pressure is created by the vacuum generated at the slot opening where section 508 meets section 512, the spring 530 may be compressed as shown in FIG. 5C, and air may flow through the check valve into the flowing water via the slot opening.

The water ingress portion 504 comprises a first section 506 having a first diameter, D1, and a second section 508 having a diameter that tapers from D1 to a second diameter, D2. The water egress portion 510 comprises a first section 512 having a diameter that tapers from D2 to D1, and a second section 514 having the first diameter, D1. In an implementation, the length of section 508 is shorter than the length of section 512. In this manner, the taper angle of section 508 is steeper than the taper angle of section 512.

The first air ingress portion 520 may comprise a cavity into which the check valve sits. The cavity may lead to the plane where section 508 meets second 512. Thus, the opening via which air may be pulled into the water may be at the point where section 508 meets section 512 and may be a slot of length L (L may, for example, be equal to D2).

When the second air ingress portion 540 is mated to the first air ingress portion, the ridge 522 in the first air ingress portion 520 may apply pressure to a first side of the gasket 534 while the ridge 542 in the second air ingress portion 540 applies pressure to a second side of the gasket 534.

FIGS. 5B and 5C illustrate operation of the check valve of the vacuum generation element, in accordance with techniques of the present application. FIGS. 5B and 5C are cross-sectional views of the check valve in the closed and open position, respectively. Shown in FIGS. 5B and 5C are the ridges 522 and 542 which apply pressure to the gasket 534. In FIG. 5B, there is insufficient flow of water through the vacuum generation module 214 to compress the spring 530. Consequently, the ball 532 is pressed against the gasket 534 forming a water-tight seal. In FIG. 5B, on the other hand, the vacuum has compressed the spring 530, thus allowing air to flow through the check valve. As shown in FIGS. 5B and 5C, the pressure applied to the gasket by the ridges 522 and 542 may cause the gasket flex and conform to the surface of the ridges 542 and 522, thus aiding the sealing ability of the check valve.

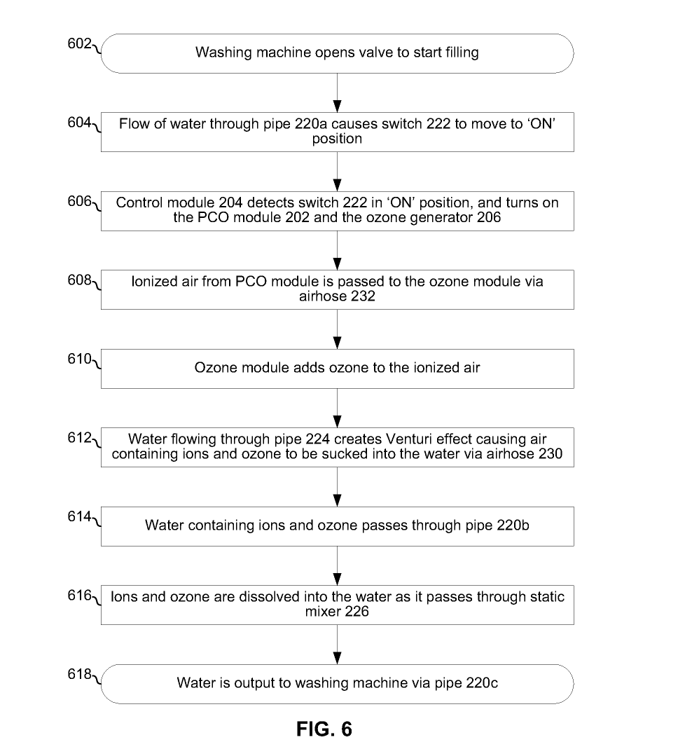

FIG. 6 is a flow chart depicting example steps for operation of a water treatment module, in accordance with techniques of the present application. In step 602, the washing machine 118 opens its valve to start filling with water. In step 604, flow of water through water-conveying element 220a causes switch 222 to move to the ON position. In step 606, the control module 204 detects that the switch 222 is in the ON position, and configures each of the PCO module 202 and the oxide generation module 206 into an ON state. In step 608, ionized air from PCO module 202 is pulled into the oxide generation module 206 via the air-conveying element 232. In step 610, the oxide generation module 206 adds oxidants to the ionized air. In step 612, water flowing through water-conveying element 224 creates a vacuum causing the ionized air containing oxidants to be pulled into the water via air-conducting element 230. In step 614, the water and ionized air containing oxidants pass through the static mixer 226, where the gasses are dissolved in the water, thus forming oxidized water. In step 618, the oxidized water is output to the washing machine via water-conveying element 220c.

While the present techniques have been described with reference to certain implementations, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present techniques not be limited to the particular implementations disclosed, but that the present techniques will include all implementations falling within the scope of the appended claims.

What is claimed is:

1. A system comprising:
a photocatalytic oxidation (PCO) element;
an oxide generation module, said oxide generation module comprising a housing, an oxide generator, and a fan arranged such that, when said fan is powered on, a ducted flow of air passes along said oxide generator;
a flow switch; and
a plurality of water-conveying elements, said water-conveying elements comprising a vacuum generation element, wherein:
while said flow switch indicates that water is not flowing through said plurality of water-conveying elements, said PCO module and said oxide generator are configured in an OFF state;
while said flow switch indicates that water is flowing through said plurality of water-conveying elements:
said fan is configured in an ON state;
said PCO module generates ionized air;
said oxide generator adds ozone to said ionized air, resulting in ionized air containing ozone;
a vacuum generated by said water flowing through said vacuum generation element pulls said ionized air containing ozone into said water.

2. The system of claim 1, wherein said oxide generator comprises a plurality of heat-conductive fins.

3. The system of claim 2, wherein said plurality of heat-conductive fins each extend radially from said oxide generator.

4. The system of claim 1, wherein said oxide generator and said fan are arranged in said housing such that said ducted flow of air substantially surrounds said oxide generator.

5. The system of claim 1, wherein said plurality of water-conveying elements comprises a static mixer.

6. The system of claim 1 comprising a leak detector that triggers an alarm upon detecting a leak.

7. A system comprising:
a photocatalytic oxidation (PCO) element;
an oxide generator;
a flow switch;
a vacuum generation element;
said vacuum generation element comprises a water ingress portion, a water egress portion, a first air ingress portion, a second air ingress portion, and a check valve;
said first air ingress portion comprises a first ridge; and
said second air ingress portion comprises a second ridge, wherein:
when said first air ingress portion is mated to said second air ingress portion, pressure is applied to a gasket of said check valve by said first ridge and said second ridge;
while said flow switch indicates that water is not flowing through said system, said PCO module and said oxide generator are configured in an OFF state;
while said flow switch indicates that water is flowing through said system:
said fan is configured in an ON state;
said PCO module generates ionized air;
said oxide generator adds ozone to said ionized air, resulting in ionized air containing ozone;
a vacuum generated by said water flowing through said vacuum generation element pulls said ionized air containing ozone into said water.

8. The system of claim 7, wherein said gasket comprises rubber.

9. The system of claim 7, wherein:
said water ingress portion of said vacuum generation element comprises:
a first section having a first diameter; and
a second section having a diameter that tapers from said first diameter to a second diameter;
said water egress portion of said vacuum generation element comprises:
a first section that tapers from said second diameter to said first diameter; and
a second section having said first diameter.

10. The system of claim 9, wherein said ionized air containing ozone is pulled into said water via a slot in said vacuum generation element, said slot located at the intersection of said second section of said water ingress portion and said first section of said water egress portion.

11. The system of claim 7, wherein said plurality of water-conveying elements comprises a static mixer.

12. The system of claim 7 comprising a leak detector that triggers an alarm upon detecting a leak.

13. A method comprising:
electronically detecting, via a flow switch, whether water is flowing through a plurality of water-conveying elements, said water-conveying elements comprising a vacuum generation element;
if said water is not flowing through said plurality of water-conveying elements, configuring a photocatalytic oxidation (PCO) element and an oxide generation module in an OFF state, wherein said oxide generation module comprises a fan, an oxide generator, and a housing that forms a duct; and
if said water is flowing through said plurality of water-conveying elements:
configuring said PCO element in an ON state to generate ionized air;
configuring said oxide generation module into an ON state such that ozone is added to said ionized air, resulting in the formation of ionized air containing ozone;
combining said ionized air containing ozone with said water via a vacuum created by said water flowing through the vacuum generation element;
generating an airflow with said fan; and
passing said airflow through said duct and along said oxide generator.

14. The method of claim 13, wherein said oxide generator comprises a plurality of heat-conductive fins.

15. The method of claim 14, wherein said plurality of heat-conductive fins extend radially from said oxide generator.

16. The method of claim 13, wherein said oxide generator is arranged in said housing such that said ducted flow of air substantially surrounds said oxide generator.

17. The method of claim 13, wherein said plurality of water-conveying elements includes a static mixer.

18. The method of claim 13, comprising a leak detector that triggers an alarm upon detecting a leak.
